(19) United States
(12) Patent Application Publication
(10) Pub. No.: US 2013/0210343 A1
(43) Pub. Date: Aug. 15, 2013

(54) METHOD OF TRANSMITTING DATA BETWEEN MOBILE DEVICES

(71) Applicant: Kun-Da Wu, Taoyuan County (TW)

(72) Inventor: Kun-Da Wu, Taoyuan County (TW)

(21) Appl. No.: 13/396,574

(22) Filed: Feb. 14, 2012

(51) Int. Cl. H04B 5/00; H04W 88/02

(52) U.S. Cl. 455/41.1

(57) ABSTRACT

A method of transmitting data between mobile devices includes selecting a file stored in a first mobile device; activating a button of the first mobile device; the first mobile device sending a file transmitting request by a first near field communication module of the first mobile device; a second near field communication module of a second mobile device receiving the file transmitting request; and the first near field communication module transmitting the file to the second near field communication module.

### BACKGROUND OF THE INVENTION

1. Field of the Invention

The present invention relates to a method of transmitting data between mobile devices, and more particularly, to a method of transmitting data between mobile devices through near field communication technology.

2. Description of the Prior Art

Though near field communication technology defined a peer-to-peer channel for mobile devices to transmit data when both devices close to be within a certain distance, lack of a explicit metaphor during operation indicating who is transmitter and who is receiver makes this technology hard for commercial application.

As related technologies improve, various types of mobile devices, such as mobile phones, are capable of exchanging data wirelessly. For example, some mobile phones can transmit data to another mobile phone through Bluetooth or Wi-Fi wireless technologies. However, before a mobile phone can transmit a file to another mobile phone, a wireless connection needs to be established between the two mobile phones. In order to establish the wireless connection, the two mobile phones need to identify each other first, then exchange Bluetooth or Wi-Fi pairing information to set up the wireless connection. Such processes are not intuitive to users, and the user may send the file to the wrong mobile device if another mobile device has a similar device name.

Without the design of metaphor, mobile devices of the prior art can not transmit any types of files to another mobile device correctly and quickly as user's wish.

### SUMMARY OF THE INVENTION

The present invention provides a method of transmitting data between mobile devices. The method comprises selecting a file stored in a first mobile device; activating a button of the first mobile device; the first mobile device sending a file transmitting request by a first near field communication module of the first mobile device; a second near field communication module of a second mobile device receiving the file transmitting request; and the first near field communication module transmitting the file to the second near field communication module.

The present invention further provides another method of transmitting data between mobile devices. The method comprises selecting a file stored in a first mobile device; activating a button of the first mobile device; the first mobile device sending a file transmitting request by a first near field communication module of the first mobile device; a second near field communication module of a second mobile device receiving the file transmitting request; the first and second near field communication modules exchanging pairing information of a first wireless module of the first mobile device with pairing information of a second wireless module of the second mobile device; and the first wireless module transmitting the file to the second wireless module.

The present invention further provides a mobile device. The mobile device comprises a memory for storing a first file, a processor for running an application program, a near field communication module coupled to the memory and the processor for transmitting and receiving data, and a button coupled to the processor. Wherein when the first file is selected and the button is activated, the application program transmits the first file to another mobile device by the near field communication module; and wherein when the near field communication module receives a file transmitting request from the other mobile device, the application program receives a second file from the other mobile device by the near field communication module.

The present invention further provides another mobile device. The mobile device comprises a memory for storing a first file, a processor for running an application program, a near field communication module coupled to the processor for transmitting and receiving data, a wireless module coupled to the memory and the processor for transmitting and receiving data, and a button coupled to the processor. Wherein when the first file is selected and the button is activated, the application program exchanges pairing information of the wireless module with pairing information of a wireless module of another mobile device by the near field communication module, and then transmits the first file to the other mobile device by the wireless module; and wherein when the near field communication module receives a file transmitting request from the other mobile device, the application program exchanges pairing information of the wireless module with pairing information of the wireless module of the other mobile device by the near field communication module, and then receives a second file from the other mobile device by the wireless module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a first embodiment of a mobile device of the present invention.

FIG. 2 is a diagram showing the mobile devices of the present invention exchanging data by near field communication

FIG. 3 is a diagram showing a second embodiment of a mobile device of the present invention.

FIG. 4 is a diagram showing the mobile devices of the present invention exchanging data wirelessly.

FIG. 5 is a flowchart showing a method of transmitting data between mobile devices of the present invention.

FIG. 6 is a flowchart showing another method of transmitting data between mobile devices of the present invention.

### DETAILED DESCRIPTION

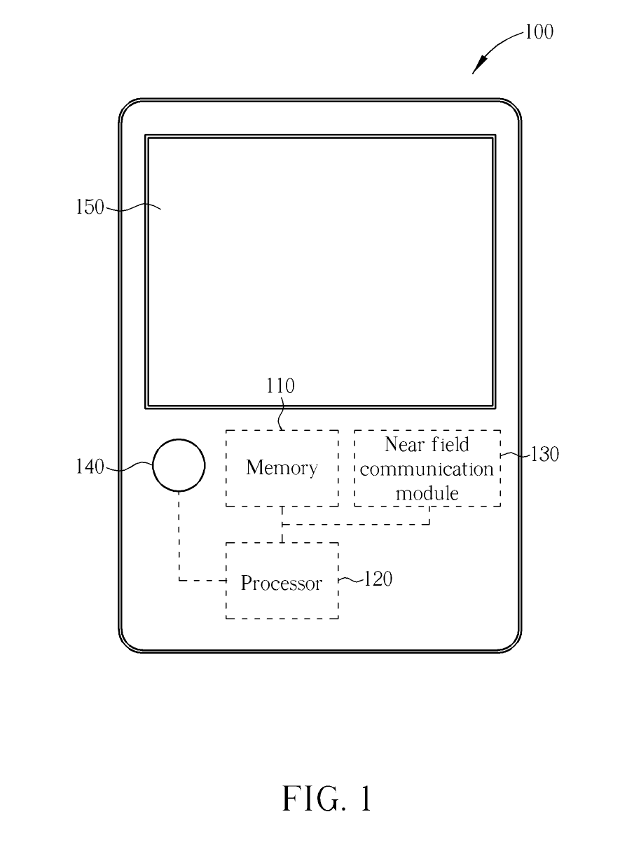

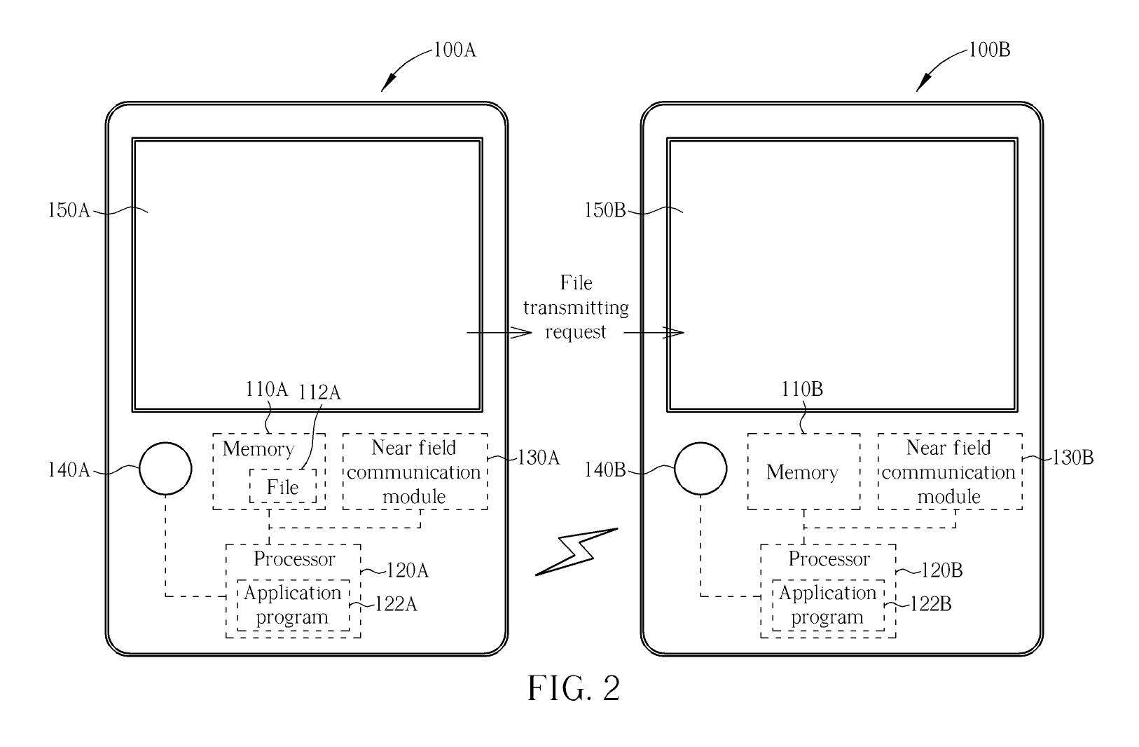

Please refer to FIG. 1 and FIG. 2 together. FIG. 1 is a diagram showing a first embodiment of a mobile device of the present invention. FIG. 2 is a diagram showing mobile devices of the present invention exchanging data by near field communication. The mobile device 100 comprises a memory 110, a processor 120, a near field communication module 130, and at least a button 140. When a first user is trying to transmit a selected file 112A stored in a memory 110A of a first mobile device 100A to a second mobile device 100B, the first user activates a button 140A to notify a processor 120A of the first mobile device 100A to run an application program 122A. The application program 122A then controls the first mobile device 100A to send a file transmitting request by a near field communication module 130A of the first mobile device 100A. If the first mobile device 100A and the second mobile device 100B are positioned within 10 cm of each other, a near field communication module 130B of the second mobile device 100B will receive the file transmitting request. A second user can activate a button 140B of the second mobile device 100B to accept the file transmitting request. After accepting the file transmitting request, the near field communication module 130A of the first mobile device 100A transmits the selected file 112A to the near field communication module 130B of the second mobile device 100B wirelessly. And a memory 110B of the second mobile device 100B can further store the file.

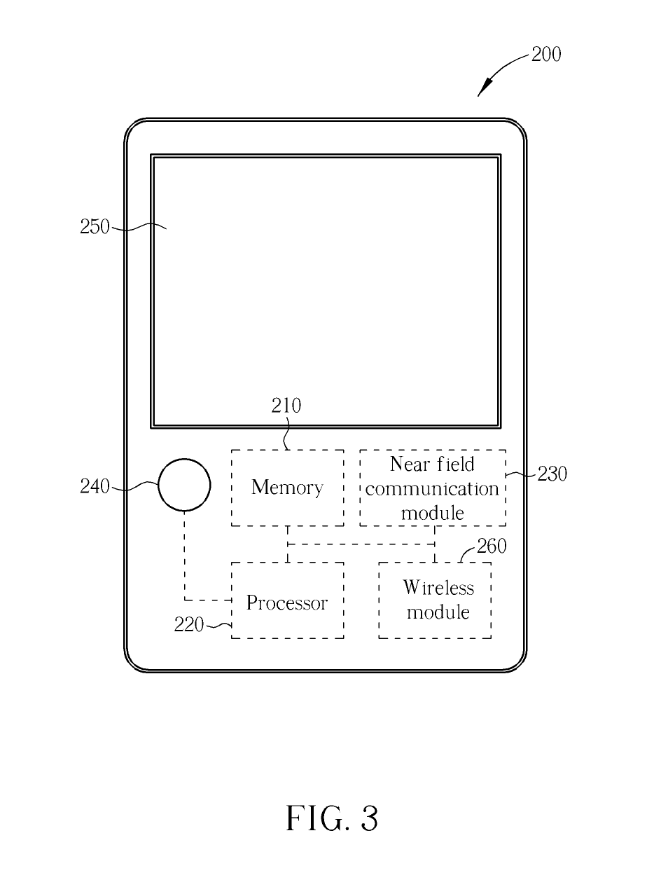

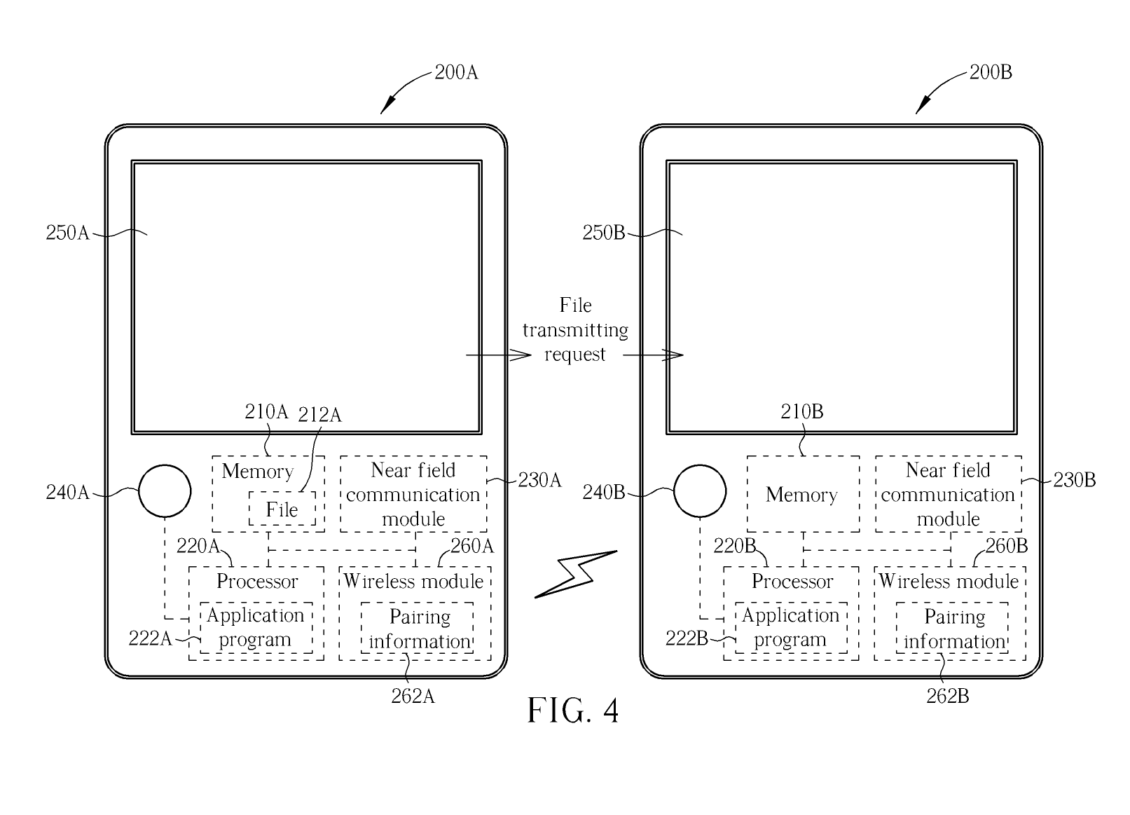

Please refer to FIG. 3 and FIG. 4 together. FIG. 3 is a diagram showing a second embodiment of a mobile device of the present invention. FIG. 4 is a diagram showing mobile devices of the present invention exchanging data wirelessly. The mobile device 200 of the present invention comprises a memory 210, a processor 220, a near field communication module 230, at least one button 240, and a wireless module 260. The wireless module 260 can be a Bluetooth module, Wi-Fi module, Ultra-Wideband (UWB) module or any other type of wireless module for transmitting and receiving data wirelessly. The second embodiment of the mobile device 200 of the present invention can be utilized to transmit large size files since the wireless module 260 has larger bandwidth. When a first user is trying to transmit a selected file 212A stored in a memory 210A of a first mobile device 200A to a second mobile device 200B, the first user activates a button 240A to notify a processor 220A of the first mobile device 200A to run an application program 222A. The application program 222A then controls the first mobile device 200A to send a file transmitting request by a near field communication module 230A of the first mobile device 200A. If the first mobile device 200A and the second mobile device 200B are positioned within 10 cm of each other, a near field communication module 230B of the second mobile device 200B will receive the file transmitting request. A second user can activate a button 240B of the second mobile device 200B to accept the file transmitting request. After accepting the file transmitting request, the near field communication module 230A of the first mobile device 200A and the near field communication module 230B of the second mobile device 200B exchange pairing information 262A of a wireless module 260A of the first mobile device 200A with pairing information 262B of a wireless module 260B of the second mobile device 200B in order to establish a wireless connection between the two wireless modules 260A, 260B. The pairing information 262A, 262B can comprise a MAC address or any other profile needed for the wireless connection. Thereafter, the wireless module 260A of the first mobile device 200A transmits the selected file 212A to the wireless module 260B of the second mobile device 200B wirelessly. And, a memory 210B of the second mobile device 200B can further store the file.

Although the button 140, 240 shown in the figures is a hardware button, the button 140, 240 can be replaced by a software button displayed on the screen 150, 250 of the mobile device 100, 200. In addition, the button 140, 240 can be a dedicated button for data transmission.

According to the above arrangement, the user of the mobile device can simply press the button for transmitting files to or receiving files from another mobile automatically. Besides, since the mobile devices utilize the near field communication modules to transmit the file or exchange the pairing information, the two mobile devices must be positioned within 10 cm of each other. The user can confirm the target mobile device to share data with precisely, which increases security of the data transmission.

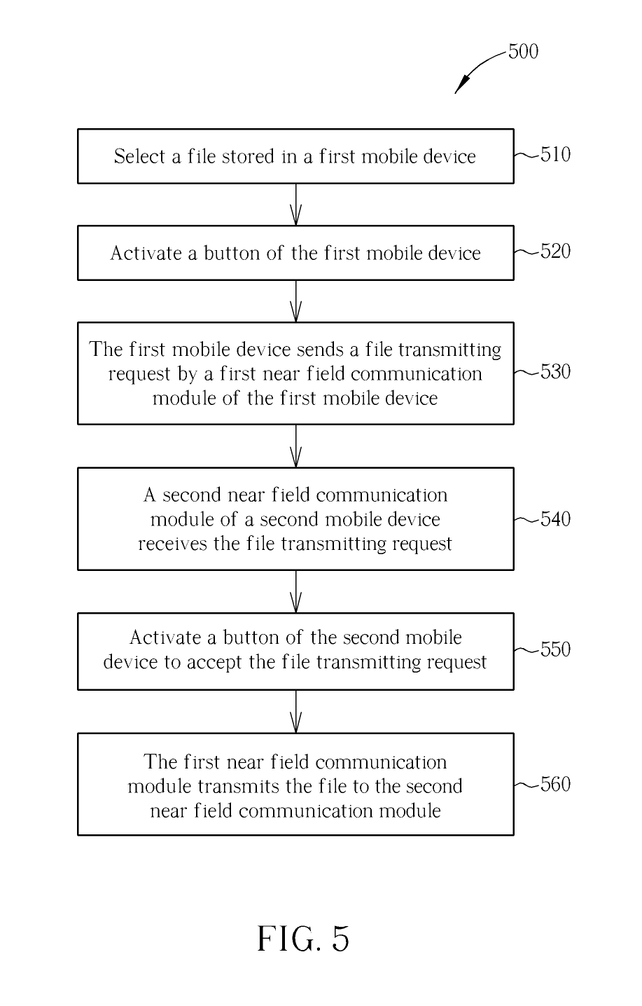

Please refer to FIG. 5. FIG. 5 is a flowchart showing a method of transmitting data between mobile devices of the present invention. The flowchart of the method of transmitting data between mobile devices comprises the following steps:

Step 510: Select a file stored in a first mobile device;

Step 520: Activate a button of the first mobile device;

Step 530: The first mobile device sends a file transmitting request by a first near field communication module of the first mobile device;

Step 540: A second near field communication module of a second mobile device receives the file transmitting request;

Step 550: Activate a button of the second mobile device to accept the file transmitting request; and

Step 560: The first near field communication module transmits the file to the second near field communication module.

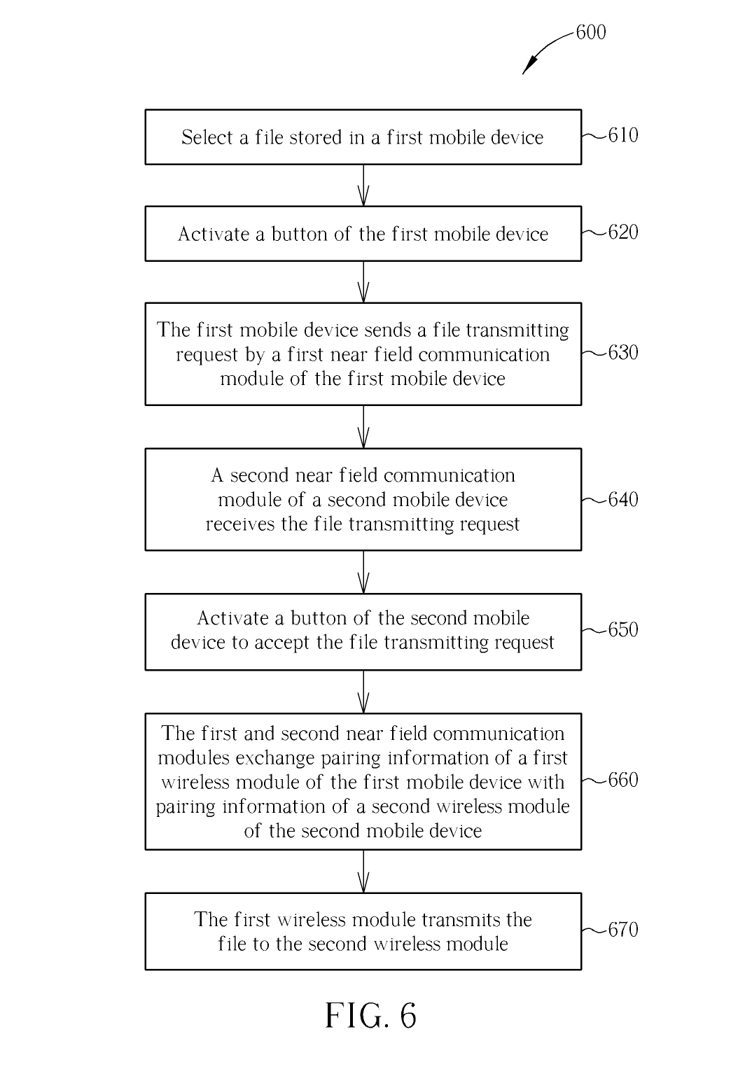

Please refer to FIG. 6. FIG. 6 is a flowchart showing another method of transmitting data between mobile devices of the present invention. The flowchart of the method of transmitting data between mobile devices comprises the following steps:

Step 610: Select a file stored in a first mobile device;

Step 620: Activate a button of the first mobile device;

Step 630: The first mobile device sends a file transmitting request by a first near field communication module of the first mobile device;

Step 640: A second near field communication module of a second mobile device receives the file transmitting request;

Step 650: Activate a button of the second mobile device to accept the file transmitting request;

Step 660: The first and second near field communication modules exchange pairing information of a first wireless module of the first mobile device with pairing information of a second wireless module of the second mobile device; and

Step 670: The first wireless module transmits the file to the second wireless module.

Basically, to achieve the same result, the steps of the flowchart 500, 600 need not be in the exact order shown and need not be contiguous, that is, other steps can be intermediate.

In contrast to the prior art, the present invention provides a method of transmitting data between mobile devices by utilizing the near field communication modules. The mobile device of the present invention can transmit a file to another mobile device correctly and quickly by simply pressing a button.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of transmitting data between mobile devices, comprising:
selecting a file stored in a first mobile device;
activating a button of the first mobile device;
the first mobile device sending a file transmitting request by a first near field communication module of the first mobile device;
a second near field communication module of a second mobile device receiving the file transmitting request; and
the first near field communication module transmitting the file to the second near field communication module.

2. The method of claim 1 further comprising:
activating a button of the second mobile device to accept the file transmitting request.

3. The method of claim 1 further comprising:
the second mobile device storing the file.

4. The method of claim 1 further comprising:
positioning the first mobile device and the second mobile device within 10 cm of each other.

5. A method of transmitting data between mobile devices, comprising:
selecting a file stored in a first mobile device;
activating a button of the first mobile device;
the first mobile device sending a file transmitting request by a first near field communication module of the first mobile device;
a second near field communication module of a second mobile device receiving the file transmitting request;
the first and second near field communication modules exchanging pairing information of a first wireless module of the first mobile device with pairing information of a second wireless module of the second mobile device; and
the first wireless module transmitting the file to the second wireless module.

6. The method of claim 5 further comprising:
activating a button of the second mobile device to accept the file transmitting request.

7. The method of claim 5 further comprising:
the second mobile device storing the file.

8. The method of claim 5 further comprising:
positioning the first mobile device and the second mobile device within 10 cm of each other.

9. The method of claim 5, wherein the pairing information comprises pairing information of Bluetooth, Wi-Fi, or Ultra-Wideband (UWB).

10. The method of claim 5, wherein the pairing information comprises a MAC address.

11. A mobile device, comprising:
a memory, for storing a first file;
a processor, for running an application program;
a near field communication module, coupled to the memory and the processor, for transmitting and receiving data; and
a button, coupled to the processor;
wherein when the first file is selected and the button is activated, the application program transmits the first file to another mobile device by the near field communication module; and
wherein when the near field communication module receives a file transmitting request from the other mobile device, the application program receives a second file from the other mobile device by the near field communication module.

12. The mobile device of claim 11, wherein the wireless module is a Bluetooth module, Wi-Fi module, or Ultra-Wideband (UWB) module.

13. The mobile device of claim 11, wherein the pairing information comprises a MAC address.

14. The mobile device of claim 11, wherein the button is a software button.

15. The mobile device of claim 11, wherein the button is a hardware button.

16. A mobile device, comprising:
a memory, for storing a first file;
a processor, for running an application program;
a near field communication module, coupled to the processor, for transmitting and receiving data;
a wireless module, coupled to the memory and the processor, for transmitting and receiving data; and
a button, coupled to the processor;
wherein when the first file is selected and the button is activated, the application program exchanges pairing information of the wireless module with pairing information of a wireless module of another mobile device by the near field communication module, and then transmits the first file to the other mobile device by the wireless module; and
wherein when the near field communication module receives a file transmitting request from the other mobile device, the application program exchanges pairing information of the wireless module with pairing information of the wireless module of the other mobile device by the near field communication module, and then receives a second file from the other mobile device by the wireless module.

17. The mobile device of claim 16, wherein the wireless module is a Bluetooth module, Wi-Fi module, or Ultra-Wideband (UWB) module.

18. The mobile device of claim 16, wherein the pairing information comprises a MAC address.

19. The mobile device of claim 16, wherein the button is a software button.

20. The mobile device of claim 16, wherein the button is a hardware button.
